(19) United States
(12) Patent Application Publication
(10) Pub. No.: US 2004/0164433 A1
(43) Pub. Date: Aug. 26, 2004

(54) Apparatus for aerating water

(75) Inventor: Arnold Jager, Burgdorf (DE)

Correspondence Address: ROBERT W. BECKER & ASSOCIATES, Suite B, 707 Highway 66 East, Tijeras, NM, 87059, US

(73) Assignee: Gummi-Jager KG GmbH & Cie, Hannover (DE)

(21) Appl. No.: 10/773,721

(22) Filed: Feb. 6, 2004

(30) Foreign Application Priority Data
Feb. 7, 2003 (DE) 103 05 203.8

(51) Int. Cl. B01F 3/04

(52) U.S. Cl. 261/122.2

(57) ABSTRACT

The invention relates to an apparatus for the introduction of gas into a liquid, especially for the aeration of water, and includes an elastic hose or tube that is disposed on a rigid profiled support member, whereby the tube has elastically expandable slits and whereby the air can escape into the water, in the form of small bubbles, through the expanded slits. The diameter of the tube is greater than the outer periphery of the profiled support member without recessed area or areas. So that when the air supply is shut off

The invention relates to an apparatus for introducing gas into a liquid, in particular for aerating water, and includes an elastic tube that is disposed on a rigid profiled support member, whereby the tube is provided with elastically expandable slits, and whereby compressed air can escape into the water, in the form of small bubbles, through the expanded slits.

With an apparatus of this type, the profiled support member is frequently a cylindrical tube. One example of such an apparatus is in DE 37 00 038 C2. The profiled support member can, however, also have a flat, rectangular, box-shaped profile.

Due to its elasticity, the hose expands when compressed air is supplied to the apparatus. The slits open, and the air escapes into the surrounding water out of the slits in the form of fine bubbles. If the supply of air is stopped, the slits close again and the tube contracts. The closing of the slits is desirable, since this prevents water from entering the apparatus and from contamination and microorganisms from settling or accumulating in the aeration system.

The hose or tube is customarily disposed with play upon the profiled support member, whereby the diameter of the tube can be 3% to 10% larger than the outer diameter of the profiled support member that the tube encases. This play is advantageous during placement of the tube onto the profiled support member, especially if tube and profiled support member have a great length, and it is advantageous with regard to a uniform formation of bubbles and good flow conditions in the liquid in which gas is to be introduced for the air that is guided through the space between the tube and the profiled support member to the slits. Furthermore, the tube can expand during operation.

Due to the play, in the position of rest, when the air supply is shut off, the tube does not rest flush upon the entire periphery of the profiled support member; instead, it forms folds at which the slits are not tightly closed, so that contaminated water can enter. In addition, damage can occur to the tube at the folds. In particular in the region of the slits, the tube can tear and must then be replaced.

To introduce gas into liquids that contain aggressive components, one preferably uses apparatus of the aforementioned type with tubes of silicone, which chemically is a very resistant material but is not very resistant to tearing. These tubes are particularly vulnerable for the aforementioned damages. Such damages are in particular also of concern where conventional tubes of EPDM are used, which have only a small proportion of so-called plasticizers.

It is an object of the invention to provide an apparatus of the aforementioned general type with which the formation of folds is avoided when the air supply is shut off.

This object is inventively realized in that the cross-section of the profiled support member exhibits one or more recessed areas. As a consequence of a concave configuration of the recessed area or areas, the outer surface of the profiled support member, upon which the tube rests in a rest condition, is enlarged to such an extent that it corresponds to the wider perimeter of the tube. Therefore, in the unpressurized state, the tube can rest flush against the outer periphery of the profiled support member. Folds are avoided. The recessed area preferably extends, with a uniform cross-section, over the entire length of the profiled member, which is also advantageous with regard to a simple manufacture thereof, for example by extrusion.

With apparatus of the aforementioned type having a profiled support member that has a flat, box-shaped profile, the tube is generally provided with slits only upon the peripheral portion that spans the upwardly directed surface of the profiled support member. Apparatus of this type can rest, and can also be secured, upon the base of the tank or reservoir that contains the water into which gas is to be introduced. It is therefore advantageous to provide the recessed area in the upwardly directed surface of the profiled support member, since the tube expands upwardly when it is supplied with air. On the underside of the profiled support member, the tube can be limited with regard to its ability to move due to the securement. Due to the flat construction, the side walls of the profiled support member are often too small for disposing recessed areas there.

With the aforementioned, frequently utilized water aerators having a cylindrical support tube, it is, in contrast, advantageous for the recessed area to be disposed at the bottom on the tube periphery. With these apparatus, the tube is primarily provided with slits on the peripheral portions disposed at the sides of the apparatus, whereas a narrower strip in the zenith and a wider strip at the bottom are free of slits. This configuration of the water aerator has proven to be advantageous in order to obtain as uniform, fine bubbles as possible. The lower portion of the support tube periphery is therefore free, and is particularly suitable for the provision of the recessed area. In addition, the cylindrical water aerators are generally disposed in the water so as to be freely floating, so that the tube can move about the periphery of the support tube in an unobstructed manner.

With cylindrical water aerators, the tube is frequently securely clamped at the ends by clamps that are disposed on the outside about the tube. The interior of the support tube can be open to the water in order to reduce the buoyancy of the apparatus while the air is pressed between the outer surface of the support tube and the hose or tube. In order with such apparatus to be able to use support tubes that are provided with recessed areas in the periphery, and which extend over the entire length of the support tube and are therefore easy to manufacture, it is possible pursuant to one advantageous specific embodiment of the invention to insert, in the region of the clamps, and into the recessed areas, fillers by means of which the outer contour of the support tube is restored to an at least approximately circular shape in order in this manner to achieve a reliable and airtight securement via the clamps.

For the airtight securement of the tube upon the support tube via clamps, it is, however, also advantageous if the ends of the support tube are adapted to the inner diameter of the perforated tube. In this case, it is inventively recommended to expand the end of the support tube to a diameter that corresponds at least to the inner diameter of the tube, whereby in this region no recessed area is present. In the region of the securement, the tube then rests tightly against the profiled support member, thus also not puckering or forming folds in this region. The tube can thus readily be secured via the securement clamp to the profiled support member. Especially in this case, it is furthermore recommended not to perforate the tube in this region. Especially if the hose has slits predominantly oriented in the longitudinal direction of the hose, which slits are longer than is the width of the securement clamps that are used, an airtightness of the securement is most easily achieved if the tube has no slits in this region.

To the extent an apparatus is used, the profile support member of which does not have a cylindrical or oval cross-section but rather a rectangular or otherwise angular cross-section, and no filler is to be inserted into the recess area, it is advantageous to widen the region of the securement in such a way that the profiled support member no longer has an undercut. With a clamp or the like, the tube can then be pressed onto the profiled support member, so that a sealing on the support member is also possible in a region of the recessed area that is present prior to the expansion or inflation.

With inventive apparatus having a cylindrical profiled support member, a further embodiment of the profile has shown to be advantageous. Such water aerators customarily have a length of 0.60 to 1.20 m. In this connection, it is generally adequate to provide the apparatus with only one recessed area. However, in particular for water aerators having a greater length, and where the aerators are supplied with air from only one side, in other words, the other end of the water aerators is free, it is recommended to provide recessed areas on both sides of the tube, so that the tube has a cat tongue like cross-sectional configuration. With greater lengths, the free end is held in position by a clamp or the like that is secured approximately at the base or rim of the tank or reservoir. This counteracts buoyancy and transverse forces that occur primarily at the free end. In addition, a greater quantity of air can be supplied to the apparatus than to an apparatus having only one recessed area.

Further details of the invention will be explained with the aid of the drawing in which an embodiment of the invention is illustrated. The drawings show:

FIG. 1 a cross-section through a first embodiment of the invention;

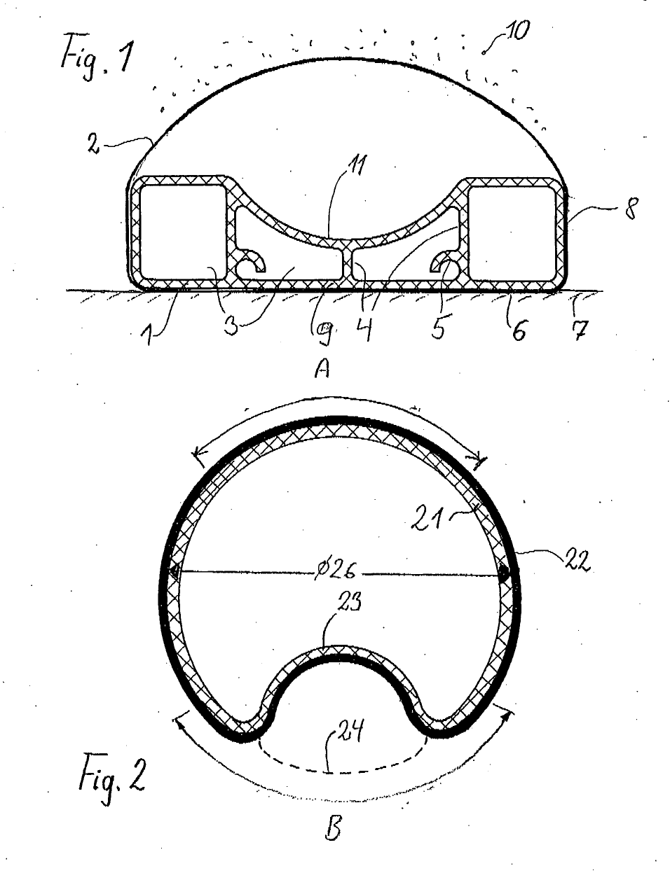

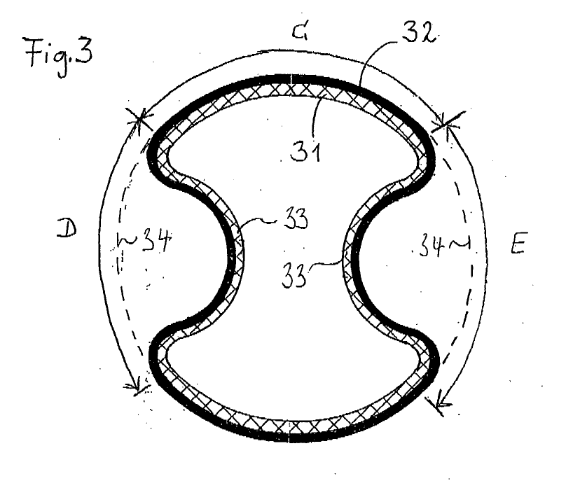

FIG. 2 a cross-section through a second embodiment of the invention; and

FIG. 3 a cross-section through a third embodiment of the invention.

FIG. 1 illustrates an inventive apparatus having a flat, box-shaped profiled support member 1 that can, for example, be comprised of a strong or rigid polymeric material or plastic, and that is encased by a hose or tube 2 of rubber or a rubber-like polymeric material. The interior of the profiled support member 1 is provided with a plurality of hollow spaces 3 that are separated from one another by elements 4 and which serve for the transport of the air. The separating elements 4 reinforce the profiled support member 1. Furthermore provided in the interior of the profiled support member 1 are projections 5 by means of which rods, e.g. of stainless steel or of glass fiber reinforced, waste water resistant, polymeric material, (not illustrated) can be received, which serve for the additional reinforcement and for the connection of a plurality of profiled support members 1.

The underside 6 of the apparatus rests upon the base 7 of a water-filled container or reservoir, or also of a natural body of water, that is to be aerated. The apparatus is held on the base by additional securement means. The apparatus can extend over a great length in a direction that is perpendicular to the illustrated cross-section.

The profiled support member 1 has low side walls 8 and a large, upwardly facing surface 9. The tube 2 is provided with fine slits only in the region that spans the surface 9. Via (not illustrated) openings in the profiled support member the air passes from the hollow spaces 3, between the surface 9 and the tube 2, and can exit out of the slits into the surrounding water in the form of fine bubbles (indicated at 10). By means of the air, the tube 2 is inflated or expanded, as illustrated in FIG. 1.

So that even with a very long apparatus (possibly several meters) a long profiled support member 1 can be introduced into a long tube 2, the perimeter of the tube 2 is greater than the outer perimeter of the profiled support member 1. In addition, it is expanded by frequent inflation. The important thing is that a recessed area 11 is disposed in the surface 9 of the profiled support member. When the aeration is terminated, the tube 2 collapses and rests or settles into the recessed area 11 without forming folds. The outer perimeter of the profiled support member 1 thus corresponds to the inner perimeter of the tube 2.

FIG. 2 illustrates an inventive apparatus having a profiled support member 21 in the form of a cylindrical tube, which can also be designated as a support tube. The support tube 21 is comprised of a rigid polymeric material. It is encased by a hose or tube 22 of rubber or a rubber-like material. The apparatus can be configured as is that in the aforementioned DE 37 00 038 C2, whereby one end thereof is secured to a supply tube, and from there can also be supplied with compressed air, and whereby the air is guided between the outer surface of the support tube 21 and the tube 22, and whereby the support tube 21 is filled over a large portion of its length with water since its free end is open. However, the apparatus can also be provided at both ends or in the middle with brackets and/or connections for the supply of air. For the most part, a great portion of the length of the apparatus floats freely in the water.

The important thing is that the support tube 21 has a recessed area 23. At that location, the wall of the support tube 21 is bent inwardly. The recessed area 23 extends over the entire, or nearly the entire, length of the support tube 21. The apparatus is disposed in the water in such a way that the recessed area 23 faces downwardly.

The tube 22 is provided with a plurality of fine slits out of which the air can escape into the surrounding water. However, no slits are provided on an upper peripheral portion A and a lower peripheral portion B of the tube 22. In FIG. 2, the tube 22 is illustrated in the state of rest in which it is not supplied with compressed air. The tube 22 rests against the outer surface of the support tube 21, whereby it is also disposed in the recessed area 23. The inner diameter of the tube 22 is greater than the outer diameter 26 of the support tube 21. The thereby resulting difference of the perimeters is compensated for by the recessed area 23, so that the tube 22 rests upon the support tube 21 without forming folds.

At the ends of the apparatus, the tube 22 is secured by clamps to the support tube 21, whereby the clamps surround the tube 22 in an annular manner and press the tube against the support tube 21 (not illustrated). Such a clamp is described in DE 37 00 038 C2. Inserted below the clamp into the recessed area 23 is a ffiller that restores the contour of the support tube 21 to a circular shape, as is illustrated at 24 by the dashed line. In this way, there is established with straightforward means an airtight connection between tube 22 and support tube 21. The filler is preferably made of rubber or a similar material.

FIG. 3 shows an embodiment of the invention that is modified relative to FIG. 2, so that the description of that embodiment is applicable here. The embodiment of FIG. 3 recommends itself for application in particular if the support tube is provided over a great length and is secured at only one side with the air supply line (not illustrated), in other words, the other end is free, but is horizontally fixed in the reservoir that contains the liquid into which gas is to be introduced (also not illustrated). The inventive apparatus is illustrated with a profiled support member 31 in the form of a cylindrical tube. Here also the support tube 31 is made of a rigid polymeric material, which is encased by a hose or tube 32 of rubber or the like. The air is pressed between the profiled support member 31 and the tube 32. The tube is provided with a plurality of slits through which the air can escape to the surrounding water. The embodiment illustrated in FIG. 3 recommends itself in particular where the apparatus has a great length, because via the two recessed areas 33 of the apparatus a larger quantity of air can be supplied.

The support tube 31 is provided with a respective recessed area 33 on both sides over practically the entire length of the support tube. The tube 32 is preferably not provided with slits over its entire periphery, but rather only in the peripheral portion C, while the remaining periphery, in particular, however, the peripheral portions D and E, are free of slits in the region of the recessed areas 33.

Also with this embodiment, the tube 32 can be secured to the support tube 31 at the ends of the apparatus via clamps (not illustrated). It is also desirable with this embodiment, as illustrated in FIG. 2 at 24, to insert in the region of the recessed areas 33 fillers that restore the cross-section of the support tube to a circular shape, as illustrated by dashed lines at 34. In this way, an air tight pressing of the tube 32 against the support tube 31 is made possible.

1. Apparatus for the introduction of gas into a liquid, especially for the aeration of water, and including an elastic hose or tube that is disposed upon a rigid profiled support member, whereby the tube has elastically expandable slits and whereby compressed air can escape into the water in the form of small bubbles, through the expanded slits, characterized in that the cross-section of the support tube (1, 21, 31) exhibits at least one recessed area (11, 23, 33).

2. Apparatus according to claim 1, characterized in that the recessed area (7, 23, 33) extends practically over the entire length of the profiled support member (1, 21, 31).

3. Apparatus according to claim 1, whereby the apparatus is disposed at the base (7) of the container that contains the water that is to be aerated, or of the body of water that is to be aerated, characterized in that the recessed area (11) is disposed on the upper side (9) of the profiled support member (1).

4. Apparatus according to claim 1, whereby the profiled support member (21) has a nearly circular cross-sectional configuration and whereby the tube (22) encases the profiled support member (21), characterized in that the recessed area (23) is disposed on the underside of the profiled support member (21).

5. Apparatus according to claim 1, whereby the profiled support member (31) has a circular or nearly circular cross-sectional configuration, and whereby the tube (32) encases the profiled support member (21), characterized in that the recessed areas (33) are disposed on the sides of the profiled support member (31).

6. Apparatus according to one of the preceding claims, whereby the ends of the tube (22, 32) are secured via clamps to the support member (1,21,31), characterized in that on the longitudinal portion of the support member (1,21,31) upon which the clamps are disposed, fillers (24, 34) are placed into the recessed area (11, 23, 33) that restore the outer contour of the support member (1,21,31) to the shape that the support member had without recessed area.

7. Apparatus according to claim 6, characterized in that the fillers (24,34) restore the outer contour of the support member (1,21,31) to a circular shape.

8. Apparatus according to claim 6 or 7, characterized in that the fillers (24,34) are made of rubber or a rubber-like material.

9. Apparatus according to one of the preceding claims, characterized in that the tube, at least at one of its ends, is secured via clamps to the support member (1,21,31) and the support member (1,21,31) in this region has no recessed area (11,23,33) and the outer perimeter of the support member (11,21,31) corresponds at least to the inner diameter of the tube (2,22,32).

10. Apparatus according to one of the preceding claims, characterized in that the tube (2,22,32), in the region of its securement to the support member (11, 21,31) has no elastically expandable slits.
